(19) United States
(12) Patent Application Publication
(10) Pub. No.: US 2020/0050608 A1
(43) Pub. Date: Feb. 13, 2020

(54) MULTI-TENANT DATA ISOLATION METHOD, APPARATUS, AND SYSTEM

(71) Applicant: HUAWEI TECHNOLOGIES CO., LTD., Shenzhen (CN)

(72) Inventors: Qingwei ZHAO, Shenzhen (CN); Chong GU, Shenzhen (CN)

(73) Assignee: HUAWEI TECHNOLOGIES CO., LTD., Shenzhen (CN)

(21) Appl. No.: 16/598,606

(22) Filed: Oct. 10, 2019

Related U.S. Application Data
(63) Continuation of application No. PCT/CN2018/078270, filed on Mar. 7, 2018.

(30) Foreign Application Priority Data
Apr. 13, 2017 (CN) 201710240807.6

(51) Int. Cl. G06F 16/2455; G06F 16/2457; G06F 9/54

(52) U.S. Cl. CPC G06F 16/24564; G06F 9/541; G06F 16/24573

(57) ABSTRACT

A multi-tenant data isolation method, an apparatus, and a system, wherein the method is applied to an SaaS application server including a service control layer and a service layer, and includes: receiving, by the service control layer, a data operation request sent by a tenant client, where the data operation request includes an identifier of a first tenant; sending, by the service control layer, the identifier of the first tenant to the service layer; determining, by the service layer according to a preset rule, that the data operation request is to perform a data operation on data storage space corresponding to the identifier of the first tenant; and performing, by the service layer, the data operation on the data storage space corresponding to the identifier of the first tenant.

### CROSS-REFERENCE TO RELATED APPLICATIONS

This application is a continuation of International Application No. PCT/CN2018/078270, filed on Mar. 7, 2018, which claims priority to Chinese Patent Application No. 201710240807.6, filed on Apr. 13, 2017, the disclosures of the aforementioned applications are hereby incorporated by reference in their entireties.

### TECHNICAL FIELD

Aspects of this application relate to the field of communications technologies, and in particular, to a multi-tenant data isolation method, an apparatus, and a system.

### BACKGROUND

Software as a service (Software as a Service, SaaS) is a software application mode in which software services are provided over the Internet, tenants lease the software services on demand, and one piece of software can usually serve a plurality of tenants at the same time. Costs of each of the plurality of tenants are reduced, thereby significantly reducing service delivery and operation and maintenance costs and maximizing benefits. However, in a multi-tenant mode, because a software stack is shared, generated and used data is also shared by a plurality of tenants. As a result, data of the plurality of tenants interferes with each other, causing a service error. Therefore, security isolation needs to be performed on multi-tenant data.

Currently, in the multi-tenant mode, there are mainly two methods for performing security isolation on multi-tenant data. In a first method, a tenant identifier is added to code of a multi-tenant application. As shown in FIG. 1, specifically, the tenant identifier is used as an application programming interface (Application Programming Interface, API) parameter, and APIs are accessed from a front-end user interface (User Interface, UI) to a service control layer, a service layer, and then a back-end database (Database), to transmit the tenant identifier layer by layer. Code corresponding to the tenant identifier is added inside an API at each layer, to implement security isolation between tenant data. In a second method, an isolation point is set in code of a multi-tenant application, and a private class loader is generated for each tenant, so that loading processing is performed at the isolation point by using a class loader corresponding to each tenant, to implement security isolation between tenant data.

In the first method, corresponding code needs to be developed for each API that treats a plurality of tenants respectively. Consequently, development workload is heavy, efficiency is low, and maintenance costs are increased due to coupling between functional code and non-functional code. In the second method, a plurality of pieces of source code need to be modified to set the isolation point. Consequently, efficiency is low, code readability is poor, and maintenance costs are also increased.

### SUMMARY

Embodiments of this application provide a multi-tenant data isolation method, an apparatus, and a system, to resolve prior-art problems of heavy workload and low efficiency of SaaS application development, and improve security of multi-tenant data isolation.

To achieve the foregoing objective, the following technical solutions are used in the embodiments of this application.

According to a first aspect, a multi-tenant data isolation method is provided, and applied to an SaaS application server. The SaaS application server includes a service control layer and a service layer. The method includes: receiving, by the service control layer, a data operation request sent by a tenant client, where the data operation request includes an identifier of a first tenant; sending, by the service control layer, the identifier of the first tenant to the service layer; determining, by the service layer according to a preset rule, that the data operation request is to perform a data operation on data storage space corresponding to the identifier of the first tenant; and performing, by the service layer, the data operation on the data storage space corresponding to the identifier of the first tenant. In the foregoing technical solution, the service control layer sends the identifier of the first tenant to the service layer, to avoid transmitting the identifier of the first tenant as an API parameter, reduce application development workload, and improve development efficiency. The service layer determines, according to the preset rule, that the data operation request is to perform the data operation on the data storage space corresponding to the identifier of the first tenant, and performs the data operation on the data storage space. In this way, a data operation is performed on data storage space corresponding to each tenant identifier when data is operated, thereby implementing isolation of multi-tenant data on physical storage, and improving security of multi-tenant data isolation.

In a first possible implementation of the first aspect, the preset rule includes a data operation request for which tenants need to be treated respectively. In the foregoing possible implementation, the service layer determines, based on the data operation request for which tenants need to be treated respectively, that the current data operation request is to perform the data operation on the data storage space corresponding to the identifier of the first tenant. In this way, a corresponding data operation is performed on the data storage space, thereby implementing multi-tenant data security isolation.

In a second possible implementation of the first aspect, the performing, by the service layer, the data operation on the data storage space corresponding to the identifier of the first tenant includes: determining an operation type of the data operation; and if the operation type is a read operation, determining, based on a mapping relationship between a tenant identifier and data storage space, the data storage space corresponding to the identifier of the first tenant, reading target data from the data storage space corresponding to the identifier of the first tenant, and modifying original data of the read operation to the target data; or if the operation type is a write operation, determining, based on a mapping relationship between a tenant identifier and data storage space, the data storage space corresponding to the identifier of the first tenant, and writing target data of the write operation into the data storage space corresponding to the first tenant. In the foregoing possible implementation, the service layer determines the operation type of the data operation, and performs a corresponding data operation in the storage space corresponding to the identifier of the first tenant based on a fact that the operation type is the read operation or the write operation, to implement multi-tenant data security isolation and ensure correctness of the data operation.

In a third possible implementation of the first aspect, an application programming interface API corresponding to the data operation is defined in a metadata manner. In the foregoing possible implementation, the API corresponding to the data operation is defined in the metadata manner. This can reduce a quantity of times that a system directly accesses a database, improve data read and write efficiency, and improve overall system performance.

In a fourth possible implementation of the first aspect, before the receiving, by the service control layer, a data operation request sent by a tenant client, the method further includes: receiving, by the service control layer, a registration request sent by the tenant client, where the registration request carries data of the first tenant; determining, by the service control layer, the identifier of the first tenant based on the registration request; allocating, by the service control layer, the data storage space corresponding to the identifier of the first tenant to the first tenant, where the data storage space corresponding to the identifier of the first tenant is used to store the data of the first tenant; and storing, by the service control layer in the mapping relationship between a tenant identifier and data storage space, the identifier of the first tenant and the data storage space corresponding to the identifier of the first tenant. In the foregoing possible implementation, when receiving the registration request sent by the tenant client, the service control layer determines the tenant identifier based on the registration request, and allocates, to the tenant, the data storage space corresponding to the tenant identifier of the tenant, where the data storage space is used for storing the data of the tenant. In this way, multi-tenant data security isolation is implemented on physical storage of multi-tenant data, thereby improving security of multi-tenant data isolation.

According to a second aspect, an SaaS application server is provided. The SaaS application server includes a control unit, configured to receive a data operation request sent by a tenant client, where the data operation request includes an identifier of a first tenant; where the control unit is further configured to send the identifier of the first tenant to a service unit; and the service unit, configured to determine, according to a preset rule, that the data operation request is to perform a data operation on data storage space corresponding to the identifier of the first tenant; where the service unit is further configured to perform the data operation on the data storage space corresponding to the identifier of the first tenant.

In a first possible implementation of the second aspect, the preset rule includes a data operation request for which tenants need to be treated respectively.

In a second possible implementation of the first aspect, the service unit is specifically configured to: determine an operation type of the data operation; and if the operation type is a read operation, determine, based on a mapping relationship between a tenant identifier and data storage space, the data storage space corresponding to the identifier of the first tenant, read target data from the data storage space corresponding to the identifier of the first tenant, and modify original data of the read operation to the target data; or if the operation type is a write operation, determine, based on a mapping relationship between a tenant identifier and data storage space, the data storage space corresponding to the identifier of the first tenant, and write target data of the write operation into the data storage space corresponding to the first tenant.

In a third possible implementation of the second aspect, an application programming interface API corresponding to the data operation is defined in a metadata manner.

In a fourth possible implementation of the second aspect, the control unit is further configured to: receive a registration request sent by the tenant client, where the registration request carries data of the first tenant; determine the identifier of the first tenant based on the registration request; allocate the data storage space corresponding to the identifier of the first tenant to the first tenant, where the data storage space corresponding to the identifier of the first tenant is used to store the data of the first tenant; and store, in the mapping relationship between a tenant identifier and data storage space, the identifier of the first tenant and the data storage space corresponding to the identifier of the first tenant.

According to a third aspect, an SaaS application server is provided. The SaaS application server includes a memory, a processor, a bus, and a communications interface, the memory stores code and data, the processor is connected to the memory by using the bus, and the processor runs the code in the memory, so that the SaaS application server performs the multi-tenant data isolation method according to any one of the first through fourth possible implementations of the first aspect.

According to a fourth aspect, a system is provided. The system includes a tenant client and an SaaS application server. The SaaS application server is the SaaS application server according to the third aspect or any one of the second through fourth possible implementations of the second aspect.

According to a fifth aspect, a computer readable storage medium is provided, where the computer readable storage medium stores a computer executable instruction, and when at least one processor of a device executes the computer executable instruction, the device performs the multi-tenant data isolation method according to any one of the possible implementations of the first aspect.

According to a sixth aspect, a computer program product is provided. The computer program product includes a computer executable instruction, and the computer executable instruction is stored in a computer readable storage medium. At least one processor of a device may read the computer executable instruction from the computer readable storage medium, and when the at least one processor executes the computer executable instruction, the device implements the multi-tenant data isolation method according to any one of the possible implementations of the first aspect.

### BRIEF DESCRIPTION OF DRAWINGS

FIG. 1 is a schematic diagram of transmission of a tenant identifier according to an embodiment of this application;

FIG. 2 is a schematic structural diagram of a communications system according to an embodiment of this application;

FIG. 3 is a schematic structural diagram of an SaaS application server according to an embodiment of this application;

FIG. 4 is a flowchart of a multi-tenant data isolation method according to an embodiment of this application;

FIG. 5 is a flowchart of another multi-tenant data isolation method according to an embodiment of this application;

FIG. 6 is a schematic structural diagram of an SaaS application server according to an embodiment of this application; and

FIG. 7 is a schematic structural diagram of another SaaS application server according to an embodiment of this application.

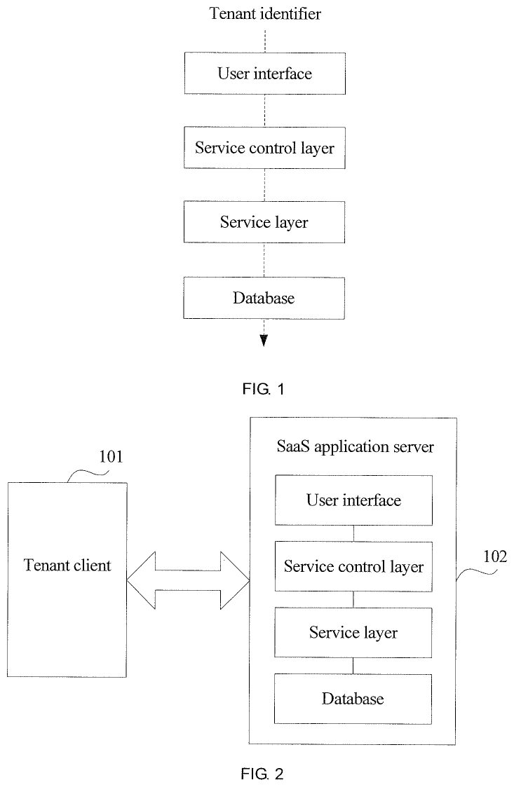

### DESCRIPTION OF EMBODIMENTS

Prior to description of the embodiments of this application, technical terms in this application are first described.

Software as a service (Software as a Service, SaaS) is an application mode in which software services are provided over the Internet, tenants lease the software services on demand, and one piece of software can usually serve a plurality of tenants at the same time. An SaaS provider builds all network infrastructure and software and hardware operation platforms that are needed by an enterprise for informatization, and are responsible for a series of services, such as pre-implementation and post-maintenance, and the enterprise can use an information system over the Internet without purchasing software and hardware, building an equipment room, recruiting technicians, and the like.

A tenant is an enterprise organization or group that orders and uses an SaaS application on demand, and a user is a user that uses the SaaS application directly. One tenant may include a plurality of users. For example, if a company A orders use of an SaaS application 1, the company A may be referred to as a tenant of the SaaS application 1, and an employee of the company A may be referred to as a user of the SaaS application 1.

Multi-tenant differentiation point is data that cannot be shared between a plurality of tenants. Generation and use of the data need to be bound to a tenant, and tenants cannot mutually access the data. For example, a cache queue is a cache queue cacheQueue shared by all tenants. A cache entry <“userDetail”, “valuea”> generated by a tenant A and a cache entry <“userDetail”, valueb> generated by a tenant B are simultaneously saved to the cache queue cacheQueue, but the tenant A can only query “valuea” by using an identifier “userDetail” and the tenant B can only query “valueb” by using an identifier “userDetail.”

An application programming interface (Application Programming Interface, API) is a collection of definitions, programs, and protocols. Communication between computer software is implemented through the API. A main function of the API is to provide a common function set, and a developer develops an application program by calling an API function, to alleviate a programming task. The API may also be used as middleware to provide data sharing for different platforms.

FIG. 2 is a schematic structural diagram of a communications system applied to an embodiment of this application. Referring to FIG. 2, the communications system includes a tenant client 101 and an SaaS application server 102. A device of the tenant client 101 may be an electronic device such as a computer, a notebook computer, a tablet computer, a mobile phone, a netbook, or the like, and may access an SaaS service provided on the SaaS application server 102 over the Internet. The SaaS application server 102 may be configured to provide an SaaS service for a tenant, perform multi-tenant data security isolation by tenant, and may include a user interface (User Interface, UI), a service control layer (Action), a service layer (Service), and a database (Database). The user interface may be configured to generate a display interface corresponding to a tenant identifier; the service control layer may be configured to control a direction of processing of each service, and is connected to a front end and a back end of a processing system of the SaaS application server 102; the service layer may also be referred to as a service logic layer, and is configured to handle a process related to a service; and the database is configured to comprehensively manage various database objects, and provides functions such as data organization, user management, and security check. Optionally, a data access layer (DAO) may also be included between the service layer and the database, and the DAO is used for data connection and database processing and may be used as middleware for data processing and database operations.

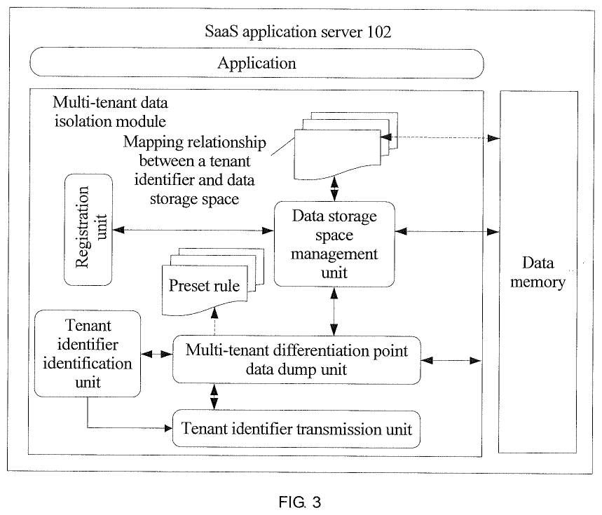

As shown in FIG. 3, FIG. 3 is a schematic structural diagram of an SaaS application server 102 according to an embodiment of this application. Referring to FIG. 3, the SaaS application server 102 may include an application, a multi-tenant data isolation module, and a data storage. The application may be a non-SaaS application that needs to provide an SaaS service, or may be an SaaS application in the prior art. The multi-tenant data isolation module includes a registration unit that belongs to a service control layer, a data storage space management unit, a tenant identifier identification unit, a tenant identifier transmission unit, and a multi-tenant differentiation point data dump unit that belongs to a service layer. The data storage is located in a memory of the SaaS application server 102 and is configured to store multi-tenant differentiation point data.

In this embodiment of this application, the registration unit is configured to receive a registration from a tenant for using an SaaS application, and allocate an identifier that is unique in a system to the tenant as a tenant identifier based on registration information of the tenant, for example, allocate a unique identifier “a1” to a tenant A1. The registration unit may further be configured to request the data storage space management unit to allocate corresponding data storage space to the tenant.

The data storage space management unit is configured to apply for dynamic storage space from the data storage as multi-tenant differentiation point data storage space, and allocate data storage space to a tenant. The data storage space is used to store tenant data of only the tenant. The tenant data is stored according to the allocated data storage space, and is forcibly isolated to ensure security of the tenant data. The data storage space management unit may also store a mapping relationship between a tenant identifier and data storage space. For example, the data storage space management unit allocates an object a1DataBlock of a map storage structure to the tenant A1 as data storage space of the tenant A1 and records a mapping relationship, such as <a1, a1DataBlock>.

The tenant identifier identification unit obtains a tenant identifier based on a data operation request of a tenant, and the data operation request includes the tenant identifier or data related to the tenant identifier, where the tenant identifier may be extracted from the data. For example, for a URL “http://www.crm.com/a1” initiated by the tenant A1, “a1” may be determined as a tenant identifier of the tenant A1.

The tenant identifier transmission unit may be used to obtain a tenant identifier in a data access request execution process if the tenant identifier needs to be used, so that no tenant identifier parameter needs to be added to an API that uses a tenant identifier, thereby improving development efficiency of tenant identifier use.

The multi-tenant differentiation point data dump unit is configured to determine, according to a preset rule, that a data operation request is to perform a data operation on data storage space corresponding to a tenant identifier, and perform the data operation on the data storage space.

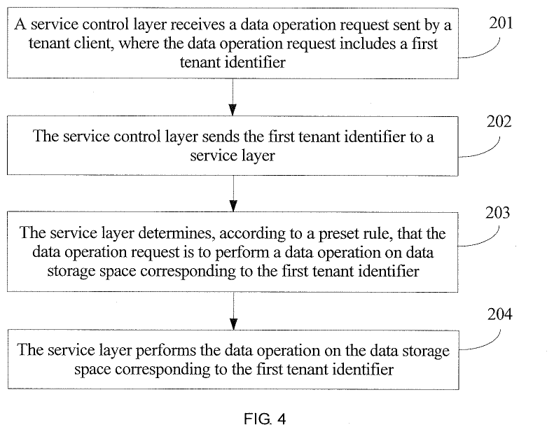

FIG. 4 is a flowchart of a multi-tenant data isolation method according to an embodiment of this application. The method is applied to the SaaS application server shown in FIG. 2 or FIG. 3. The SaaS application server includes a service control layer and a service layer. Referring to FIG. 4, the method includes the following steps.

Step 201: The service control layer receives a data operation request sent by a tenant client, where the data operation request includes an identifier of a first tenant.

The SaaS application server may provide SaaS services for a plurality of tenants. A first tenant may be any one of the plurality of tenants, and a user of the first tenant may send a data operation request to the SaaS application server by using the tenant client, for example, may send the data operation request by using a browser on a device of the tenant client, so that the service control layer of the SaaS application server receives the data operation request.

In addition, the data operation request includes the identifier of the first tenant. This means that the data operation request directly includes the identifier of the first tenant, or includes information related to the identifier of the first tenant. When receiving the data operation request, the service control layer may extract the identifier of the first tenant from the information related to the identifier of the first tenant.

Step 202: The service control layer sends the identifier of the first tenant to the service layer.

When the data operation request sent by the tenant client directly includes the identifier of the first tenant, the service control layer may directly send the identifier of the first tenant to the service layer. When the data operation request sent by the tenant client includes the information related to the identifier of the first tenant, the service control layer may send the identifier of the first tenant to the service layer after extracting the identifier of the first tenant.

For example, the service control layer may transmit the identifier of the first tenant to the service layer by using the following code segment, and may also transmit the identifier of the first tenant to a DAO layer. In this way, the identifier of the first tenant is transmitted successively from the service control layer to the service layer and then DAO layers. The identifier of the first tenant may be obtained by using transport.getTenant( ).

MutitenantTransport transport=new MutitenantTransport( );//Creating a channel for a tenant

transport.set(“a1”);//Transmitting the identifier of the first tenant

MutitenantTransport is defined as follows:

```
  public class MutitenantTransport implements Runnable
  {
```

private final static ThreadLocal tenantLocal = new
ThreadLocal( );
public void setTenant(Sting tenantid)
{

tenantLocal.set(new String(tenantid));//Transparently transmitting a

tenant identifier, such as a1

}
public String getTenant( )

{
return String.valueOf(ThreadLocal.get( ))//Returning a tenant

identifier

}
}

In addition, a manner of obtaining the identifier of the first tenant is as follows:

MutitenantTransport myTransport=new MutitenantTransport( );

myTransport.getTenant( );//Obtaining a tenant identifier, such as a1

Step 203: The service layer determines, according to a preset rule, that the data operation request is to perform a data operation on data storage space corresponding to the identifier of the first tenant.

The data operation request sent by the tenant client may be classified into two types: a first type is a data operation request for which a plurality of tenants need to be treated respectively, that is, different tenants need to be treated respectively for this type of data operation request, and this type of data operation is a data operation to be performed on respective data of the different tenants; and a second type is a data operation request for which a plurality of tenants do not need to be treated respectively, that is, different tenants do not need to be treated respectively for this type of data operation request, and this type of data operation is a data operation to be performed on shared data of the plurality of tenants.

In this embodiment of this application, the preset rule may be set beforehand. For example, the preset rule may include a data operation request for which tenants need to be treated respectively. For example, the data operation request for which tenants need to be differentiated may be a request for performing a data operation on data defined in a <key, value> format in a cache, a message, or the like. Operation data keys of all tenants is the same but value of each tenant that is corresponding to the keys is different data. Therefore, multi-tenant data needs to be isolated to ensure service correctness and security. The data storage space corresponding to the identifier of the first tenant is allocated to the first tenant and used to store data of the first tenant. The data storage space may be located in a memory of the SaaS application server.

Specifically, when the service layer receives the data operation request sent by the service control layer, the service layer may determine, according to the preset rule, whether the data operation request is a data operation request for which tenants need to be treated respectively, and if the service layer determines that the data operation request is a data operation request for which a plurality of tenants need to be treated respectively, the service layer determines that the data operation request is to perform a data operation on the data storage space corresponding to the identifier of the first tenant.

Step 204: The service layer performs the data operation on the data storage space corresponding to the identifier of the first tenant.

An operation type corresponding to the data operation may be a write operation, or may be a read operation. When the data operation is a write operation, the service layer may write target data into the data storage space corresponding to the identifier of the first tenant. When the data operation is a read operation, the service layer may read target data from the data storage space corresponding to the identifier of the first tenant. The target data is operation data corresponding to the data operation and is data of the first tenant.

In addition, an application interface API corresponding to the data operation may be defined in a metadata manner, that is, stored in the data storage space corresponding to the identifier of the first tenant by using a <key, value> structure manner. This reduces direct access of the system to a database, improves data read and write efficiency, and improves overall system performance. key and value may be referred to as parameter names, a parameter value of key may be a tenant identifier, and a parameter value of value may be data of a tenant. The <key, value> structure manner may be shown in Table 1 below.

TABLE 1

| Parameter name | Parameter value |
|---|---|
| key | tenantDetail |
| value | {address: xxx, phone:28770808, |
| | ename:a1} |

For example, if the identifier of the first tenant is “huawei”, and application programming interfaces APIs that need to be defined may include an API addCache (String key, String value) and an API queryCache (String key), “addCache” and “queryCache” may be defined by using the following code segment:

<xml>
<pointset>//Differentiation point set

<point package=”com.huawei.crm”

class=”Cache”>//Differentiation point, defining a specific type

<api name-”addCache”
type=”writing”relate=”queryCache”>

//Defining a differentiation point, namely, an API name

<parameters>//Differentiation point: API parameter set

<parameter name=”key”

type=”String”/>//Parameter name and data type

<parameter name=”value” type=”String” is

Value=”key”/>//Parameter name and data type

</parameters>

</api>

</point>
<point package=”com.huawei.crm”
class=”Cache”>//differentiation

Differentiation point, defining a specific type is defined

<api name=”queryCache” type=”query”>//Defining a

differentiation point, that is, an API name

<parameters>//Differentiation point: API parameter set

<parameter name=”key” type=”String” />//Parameter name and

data type

</parameters>

</api>

</point>
</pointset>
</xml>

Specifically, that the service layer performs the data operation on the data storage space corresponding to the identifier of the first tenant may include step S2041 to step S2043. Details are as follows.

Step S2041: The service layer determines an operation type of the data operation.

The operation type of the data operation may be a read operation or a write operation. When the service layer determines that the data operation request is to perform a data operation on the data storage space corresponding to the identifier of the first tenant, the service layer may determine the operation type of the data operation. If it is determined that the operation type is a read operation, step S2 is performed; and if it is determined that the operation type is a write operation, step S3 is performed.

Step S2042: If the operation type is a read operation, determine, based on a mapping relationship between a tenant identifier and data storage space, the data storage space corresponding to the identifier of the first tenant, and read target data from the data storage space corresponding to the identifier of the first tenant, and modify original data of the read operation to the target data.

The mapping relationship between a tenant identifier and data storage space is used to indicate a correspondence between a tenant and data storage space allocated to the tenant, and the mapping relationship between a tenant identifier and data storage space may be stored in a file form. For example, the mapping relationship between a tenant identifier and data storage space may be shown in Table 2 below, and data storage space corresponding to each tenant identifier may be represented by a corresponding address (Address) thereof. When the service layer determines that the data operation is a read operation, the service layer may obtain, based on the identifier of the first tenant from the mapping relationship between a tenant identifier and data storage space shown in Table 2 below, that an address of the data storage space corresponding to the identifier of the first tenant ID1 is Add_1, so as to read the target data from the data storage space indicated by Add_1.

TABLE 2

| Tenant identifier | Address of data storage space |
|---|---|
| ID1 | Add_1 |
| ID2 | Add_2 |
| . . . | . . . |

It should be noted that the mapping relationship between a tenant identifier and data storage space shown in Table 2 is merely an example, and sets no limitation on this embodiment of this application.

In addition, the original data of the read operation is data that the service layer reads from a shared data storage of the SaaS application server before reading the target data from the data storage space corresponding to the identifier of the first tenant. Therefore, after the service layer reads the target data, the service layer replaces the read original data with the target data. It should be noted that the service provided in this application may be an SaaS service provided by a non-SaaS application. In other words, for a user, the application providing the service is a non-SaaS application that does not treat different tenants respectively, and data of different tenants is jointly stored in shared data storage space, and the data operation is to read or write data in the shared data storage space. In this application, after reading the target data, the service layer replaces the read original data with the target data, to avoid data of different tenants in the shared data storage space from interfering with each other (for example, data of a tenant A is replaced by data of a tenant B), or data from being accessed by other tenants, thereby improving tenant data security.

Step S2043: If the operation type is a write operation, determine, based on the mapping relationship between a tenant identifier and data storage space, the data storage space corresponding to the identifier of the first tenant, and write target data of the write operation into the data storage space corresponding to the first tenant.

For example, the mapping relationship between a tenant identifier and data storage space is shown in Table 2. When the service layer determines that the data operation is a write operation, the service layer may obtain, based on the identifier of the first tenant from the mapping relationship between a tenant identifier and data storage space shown in Table 2, that an address of the data storage space corresponding to the identifier of the first tenant ID1 is Add_1, so as to write the target data of the write operation into the data storage space indicated by Add_1.

A code segment MultiteantPartitionInterceptor used by the service layer to perform a data operation on the data storage space corresponding to the identifier of the first tenant (huawei) may be as follows:

package com.huawei.crm.multitenant
public class MultiteantPartitionInterceptor r implement
MethodBeforeAdvice, AfterReturningAdvice {

/**preprocessing**/
public void before(Method method, Object[ ] args, Object target)
{
if(operating.equal(”writing”))//Multi-tenant differentiation point of
write

{

/**

A differentiation point parameter name and parameter value are obtained, and the differentiation point parameter name and parameter value are stored in a <parameter name, parameter value> structure in data storage space allocated to a tenant.

**/
}
else if(operating.equal(”reading”))//Multi-tenant differentiation point of
read
{

/**

A differentiation point parameter name and parameter value are obtained by reading the value based on the parameter name from data storage space allocated to a tenant.

**/
}
/**post-processing**/
public void after(Method method, Object[ ] args, Object target)
{

/**When a multi-tenant differentiation point is queried data, after execution of the differentiation point is completed, a value read from data storage space allocated to a tenant is forcibly set as a value in a returned result

**/

Object result=data;//Data read from data storage space allocated

to a tenant

}
}

Further, after the service layer reads the target data according to step S2, the service layer may further delete the original data from the shared data storage of the SaaS application server; or after writing the target data according to step S3, the service layer deletes the target data from the shared data storage of the SaaS application server, to save storage space of the SaaS application server.

In this embodiment of this application, when the service control layer receives the data operation request that is sent by the tenant client and that includes the identifier of the first tenant, the service control layer sends the identifier of the first tenant to the service layer, to avoid transmitting the identifier of the first tenant as an API parameter, thereby reducing application development workload, and improving development efficiency. When the service layer receives the identifier of the first tenant, the service layer determines, according to the preset rule, that the data operation request is to perform the data operation on the data storage space corresponding to the identifier of the first tenant, and then performs the data operation on the data storage space. In this way, a data operation is performed on data storage space corresponding to each tenant identifier when data needs to be operated, thereby implementing isolation of multi-tenant data on physical storage, and improving security of multi-tenant data isolation. In addition, in this embodiment of this application, source code that provides the SaaS service application does not need to be modified when multi-tenant data isolation is performed. The code is highly readable, and maintenance costs are reduced.

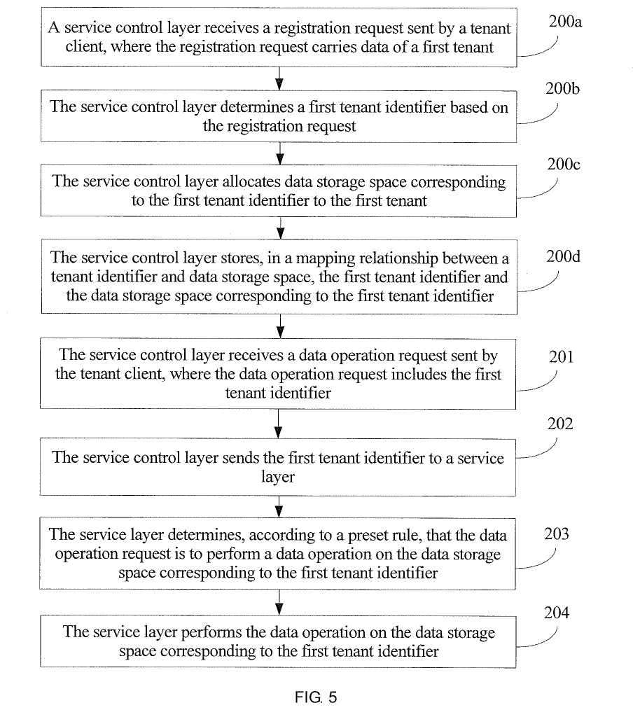

Further, the tenant client may further send a registration request to the SaaS application server, so that the SaaS application server allocates the tenant client a unique tenant identifier and the data storage space corresponding to the tenant identifier. Specifically, referring to FIG. 5, before step 201, the method may further include step 200a to step 200d.

Step 200a: The service control layer receives a registration request sent by the tenant client, where the registration request carries data of a first tenant.

When the first tenant needs to use an SaaS service provided by the SaaS application server, the first tenant may fill in the data of the first tenant by using the tenant client, and the tenant client may send the registration request that carries the data of the first tenant to the SaaS application server, so that the service control layer of the SaaS application server may receive the registration request. The data of the first tenant is related to the SaaS service used by the first tenant. For example, the SaaS service may be customer relationship management (Customer Relationship Management, CRM), and the first tenant expects to purchase office supplies through the CRM. The data of the first tenant may be a company name, a ship-to address, a contact phone number, and the like.

Step 200b: The service control layer determines the identifier of the first tenant based on the registration request.

When the service control layer receives the registration request, the service control layer may allocate the identifier of the first tenant to the first tenant, and the identifier of the first tenant is used to uniquely identify the first tenant. For example, the identifier of the first tenant may be a name, an identification code, or the like of the first tenant, which is not limited in this embodiment of this application.

Step 200c: The service control layer allocates the data storage space corresponding to the identifier of the first tenant to the first tenant, where the data storage space corresponding to the identifier of the first tenant is used to store the data of the first tenant.

The service control layer may allocate the data storage space belonging to the first tenant to the first tenant, that is, allocate the data storage space corresponding to the identifier of the first tenant. The data storage space corresponding to the identifier of the first tenant is used to separately store the data of the first tenant, so that the service control layer may allocate corresponding data storage space to each of a plurality of different tenants when the plurality of different tenants perform registration, and store data of the plurality of different tenants in different data storage space, thereby implementing complete isolation of the data of the plurality of tenants, and ensuring security of data of different tenants.

For example, if the identifier of the first tenant is a1, the service control layer may allocate the data storage space to the first tenant by using the following code: “Map a1 Block=new HashMap<String,Object>( );”.

Step 200d: The service control layer stores, in the mapping relationship between a tenant identifier and data storage space, the identifier of the first tenant and the data storage space corresponding to the identifier of the first tenant.

After the service control layer allocates the corresponding data storage space to the first tenant, the service control layer may store, in the mapping relationship between a tenant identifier and data storage space, the identifier of the first tenant and the data storage space corresponding to the identifier of the first tenant, so that when a data operation is performed on the data of the first tenant, the data storage space corresponding to the first tenant may be determined by using the mapping relationship between a tenant identifier and data storage space, so as to perform the corresponding data operation.

For example, if the identifier of the first tenant is a1, the service control layer may store, in the mapping relationship between a tenant identifier and data storage space, the identifier of the first tenant and the data storage space corresponding to the identifier of the first tenant by using the following code:

Map tenantBlocks=new HashMap<String,Object>( );//Recording a mapping relationship record set

tenantBlocks.put(“a1”, a1 Block);//Storing a mapping relationship between a1 and corresponding data storage space

In this embodiment of this application, when the service control layer receives the registration request sent by the tenant client, the service control layer determines the identifier of the first tenant based on the registration request, and allocates, to the first tenant, the data storage space corresponding to the identifier of the first tenant, where the data storage space is used for storing the data of the first tenant. In this way, multi-tenant data security isolation is implemented on physical storage of multi-tenant data, thereby improving security of multi-tenant data isolation.

The foregoing describes the solutions provided in the embodiments of this application mainly from a perspective of interaction between network elements. It may be understood that, to implement the foregoing functions, the network elements, such as the device of the tenant client and the SaaS application server, include corresponding hardware structures and/or software modules for executing the functions. A person of ordinary skill in the art should easily be aware that, in combination with the examples described in the embodiments disclosed in this specification, network elements and algorithms steps may be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of this application.

In the embodiments of this application, function module division may be performed on the SaaS application server according to the foregoing method examples. For example, each function module may be obtained by division according to a corresponding function, or two or more functions may be integrated into one processing module. The integrated module may be implemented in a form of hardware, or may be implemented in a form of a software functional module. It should be noted that, in this embodiment of this application, module division is an example, and is merely a logical function division. In actual implementation, another division manner may be used.

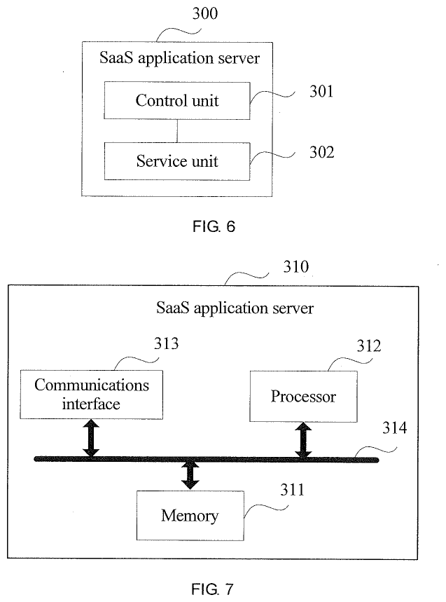

FIG. 6 is a possible schematic structural diagram of the SaaS application server 300 in the foregoing embodiments when division of function modules is performed for corresponding functions. The SaaS application server 300 includes a control unit 301 and a service unit 302. The control unit 301 is configured to perform step 201 and step 202 in FIG. 4, and step 200a to step 202 in FIG. 5; and the service unit 302 is configured to perform step 203 and step 204 in FIG. 4 or FIG. 5. It should be noted that the control unit 301 may be an integrated unit of the registration unit, the data storage space management unit, the tenant identifier identification unit, and the tenant identifier transmission unit that are in the SaaS application server shown in FIG. 3. The service unit 302 may be the multi-tenant differentiation point data dump unit in the SaaS application server shown in FIG. 3. All related content of the steps in the foregoing method embodiments may be cited in function description of a corresponding function module, and details are not described herein again.

In hardware implementation, the control unit 301 and the service unit 302 may be a processor. The SaaS application server may also include a communications interface.

FIG. 7 is a schematic diagram of a possible logical structure of an SaaS application server 310 in the foregoing embodiments according to an embodiment of this application. The SaaS application server 310 includes a processor 312, a communications interface 313, a memory 311, and a bus 314. The processor 312, the communications interface 313, and the memory 311 are connected to each other by using the bus 314. In this embodiment of this application, the processor 312 is configured to control and manage an action of the SaaS application server 310, for example, the processor 312 is configured to perform step 201 to step 204 in FIG. 4, step 200a to step 204 in FIG. 5, and/or other processes of the technology described in this specification. The communications interface 313 is configured to support communication of the SaaS application server 310. The memory 311 is configured to store program code and data of the SaaS application server 310.

The processor 312 may be a central processing unit, a general-purpose processor, a digital signal processor, an application-specific integrated circuit, a field programmable gate array or another programmable logical device, a transistor logical device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of a digital signal processor and a microprocessor. The bus 314 may be a peripheral component interconnect (Peripheral Component Interconnect, PCI) bus, an extended industry standard architecture (Extended Industry Standard Architecture, EISA) bus, or the like. The bus may be classified into an address bus, a data bus, a control bus, and the like. For ease of representation, only one thick line is used to represent the bus in FIG. 7, but this does not mean that there is only one bus or only one type of bus.

In another embodiment of this application, a computer readable storage medium is further provided. The computer readable storage medium stores a computer executable instruction, and when at least one processor of a device executes the computer executable instruction, the device performs the multi-tenant data isolation method provided in FIG. 4 or FIG. 5.

In another embodiment of this application, a computer program product is further provided. The computer program product includes a computer executable instruction, and the computer executable instruction is stored in a computer readable storage medium. At least one processor of a device may read the computer executable instruction from the computer readable storage medium, and when the at least one processor executes the computer executable instruction, the device implements the multi-tenant data isolation method provided in FIG. 4 or FIG. 5.

In another embodiment of this application, a system is further provided. The system includes a tenant client and an SaaS application server. The SaaS application server may be the SaaS application server shown in FIG. 6 or FIG. 7.

In this embodiment of this application, when a service control layer receives a data operation request that is sent by a tenant client and that includes an identifier of a first tenant, the service control layer sends the identifier of the first tenant to a service layer, to avoid transmitting the identifier of the first tenant as an API parameter, thereby reducing application development workload, and improving development efficiency. When the service layer receives the identifier of the first tenant, the service layer determines, according to a preset rule, that the data operation request is to perform a data operation on data storage space corresponding to the identifier of the first tenant, and then performs the data operation on the data storage space. In this way, a data operation is performed on data storage space corresponding to each tenant identifier when data needs to be operated, thereby implementing isolation of multi-tenant data on physical storage, and improving security of multi-tenant data isolation. In addition, in this embodiment of this application, source code that provides an SaaS service application does not need to be modified when multi-tenant data isolation is performed. The code is highly readable, and maintenance costs are reduced.

In conclusion, the foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A multi-tenant data isolation method, wherein the method is applied to a software as a service (SaaS) application server, the SaaS application server comprises a service control layer and a service layer, and the method comprises:
receiving, by the service control layer, a data operation request sent by a tenant client, wherein the data operation request comprises an identifier of a first tenant;
sending, by the service control layer, the identifier of the first tenant to the service layer;
determining, by the service layer according to a preset rule, that the data operation request is to perform a data operation on data storage space corresponding to the identifier of the first tenant; and
performing, by the service layer, the data operation on the data storage space corresponding to the identifier of the first tenant.

2. The method according to claim 1, wherein the preset rule comprises a data operation request for which tenants need to be treated respectively.

3. The method according to claim 1, wherein the performing, by the service layer, the data operation on the data storage space corresponding to the identifier of the first tenant comprises:
determining an operation type of the data operation; and
if the operation type is a read operation, determining, based on a mapping relationship between a tenant identifier and data storage space, the data storage space corresponding to the identifier of the first tenant, reading target data from the data storage space corresponding to the identifier of the first tenant, and modifying original data of the read operation to the target data; or
if the operation type is a write operation, determining, based on the mapping relationship between the tenant identifier and the data storage space, the data storage space corresponding to the identifier of the first tenant, and writing target data of the write operation into the data storage space corresponding to the first tenant.

4. The method according to claim 1, wherein an application programming interface (API) corresponding to the data operation is defined in a metadata manner.

5. The method according to claim 1, wherein before the receiving, by the service control layer, the data operation request sent by the tenant client, the method further comprises:
receiving, by the service control layer, a registration request sent by the tenant client, wherein the registration request carries data of the first tenant;
determining, by the service control layer, the identifier of the first tenant based on the registration request;
allocating, by the service control layer, the data storage space corresponding to the identifier of the first tenant to the first tenant, wherein the data storage space corresponding to the identifier of the first tenant is used to store the data of the first tenant; and
storing, by the service control layer in a mapping relationship between a tenant identifier and data storage space, the identifier of the first tenant and the data storage space corresponding to the identifier of the first tenant.

6. An SaaS application server, wherein the SaaS application server comprises:
at least one processor;
a non-transitory computer-readable storage medium coupled to the at least one processor and storing programming instructions for execution by the at least one processor, wherein the programming instructions instruct the at least one processor to:
receive a data operation request sent by a tenant client, wherein the data operation request comprises an identifier of a first tenant; wherein
send the identifier of the first tenant to a service unit; and
determine, according to a preset rule, that the data operation request is to perform a data operation on data storage space corresponding to the identifier of the first tenant;
perform the data operation on the data storage space corresponding to the identifier of the first tenant.

7. The SaaS application server according to claim 6, wherein the preset rule comprises a data operation request for which tenants need to be treated respectively.

8. The SaaS application server according to claim 6, wherein the programming instructions instruct the at least one processor to:
determine an operation type of the data operation; and
determine, if the operation type is a read operation, based on a mapping relationship between a tenant identifier and data storage space, the data storage space corresponding to the identifier of the first tenant, read target data from the data storage space corresponding to the identifier of the first tenant, and modify original data of the read operation to the target data; or
determine, if the operation type is a write operation, based on the mapping relationship between the tenant identifier and the data storage space, the data storage space corresponding to the identifier of the first tenant, and write target data of the write operation into the data storage space corresponding to the first tenant.

9. The SaaS application server according to claim 6, wherein an application programming interface API corresponding to the data operation is defined in a metadata manner.

10. The SaaS application server according to claim 6, wherein the programming instructions instruct the at least one processor to:
receive a registration request sent by the tenant client, wherein the registration request carries data of the first tenant;
determine the identifier of the first tenant based on the registration request;
allocate the data storage space corresponding to the identifier of the first tenant to the first tenant, wherein the data storage space corresponding to the identifier of the first tenant is used to store the data of the first tenant; and
store, in a mapping relationship between a tenant identifier and data storage space, the identifier of the first tenant and the data storage space corresponding to the identifier of the first tenant.

11. A system comprising:
a tenant client; and the SaaS application server according to claim 6.
